(19) United States
(12) Patent Application Publication
(10) Pub. No.: US 2009/0020112 A1
(43) Pub. Date: Jan. 22, 2009

(54) METHOD FOR BREAKING DOWN CELLULOSE

(75) Inventors: Klemens Massonne, Bad Durkheim (DE); Giovanni D'Andola, Heidelberg (DE); Veit Stegmann, Mannheim (DE); Werner Mormann, Siegen (DE); Markus Wezstein, Kirchhundem (DE); Wei Leng, Siegen (DE); Stephan Freyer, Neustadt (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/280,713

(22) PCT Filed: Feb. 28, 2007
(86) PCT No.: PCT/EP07/51872

§ 371 Date: Aug. 26, 2008

(30) Foreign Application Priority Data
Mar. 8, 2006 (DE) 102006011076.5
Sep. 9, 2006 (DE) 102006042891.9

(51) Int. Cl. C13K 1/02

(52) U.S. Cl. 127/37

(57) ABSTRACT

The present invention describes a process for the degradation of cellulose by dissolving the cellulose in an ionic liquid and treating it at elevated temperature, if appropriate in the presence of water.

The present invention describes a process for the degradation of cellulose by dissolving cellulose in an ionic liquid and treating it at elevated temperature, if appropriate in the presence of water.

Cellulose is the most important renewable raw material and represents an important starting material for, for example, the textile, paper and nonwovens industry. It also serves as raw material for derivatives and modifications of cellulose, including cellulose ethers such as methylcellulose and carboxymethylcellulose, cellulose esters based on organic acids, e.g. cellulose acetate, cellulose butyrate, and also cellulose esters based on inorganic acids, e.g. cellulose nitrate, and others. These derivatives and modifications have a variety of uses, for example in the food industry, building industry and surface coatings industry.

Cellulose is characterized by insolubility, in particular in customary solvents of organic chemistry. In general, N-methylmorpholine N-oxide, anhydrous hydrazine, binary mixtures such as methylamine/dimethyl sulfoxide or ternary mixtures such as ethylenediamine/SO₂/dimethyl sulfoxide are nowadays used as solvents. However, it is also possible to use salt-comprising systems such as LiCl/dimethylacetamide, LiCl/N-methylpyrrolidone, potassium thiocyanate/dimethyl sulfoxide, etc.

Rogers et al. have recently reported (J. Am. Chem. Soc. 124, 4974 (2002)), that cellulose is soluble in ionic liquids such as [1-butyl-3-methylimidazolium] chloride.

Cellulose is usually characterized by the average degree of polymerization (DP). The DP of cellulose is dependent on its origin; thus, the DP of raw cotton can be up to 12,000. Cotton linters usually have a DP of from 800 to 1800 and in the case of wood pulp it is in the range from 600 to 1200. However, for many applications it is desirable to use cellulose having a DP which is lower than the values given above and it is also desirable to reduce the proportion of polymers having a long chain length.

Various methods of degrading cellulose are known; these can be divided into four groups: mechanical degradation, thermal degradation, degradation by action of radiation and chemical degradation (D. Klemm et al., Comprehensive Cellulose Chemistry, Vol. 1, pp. 83-127, Wiley Verlag, 1998).

In the case of mechanical degradation, for example dry or wet milling, it is a disadvantage that the DP of the cellulose is reduced to only a small extent.

Known chemical degradation methods are acidic, alkaline and oxidative degradation and also enzymatic degradation.

In heterogeneous acidic degradation, the cellulose is, for example, suspended in dilute mineral acid and treated at elevated temperature. In this method, it is found that the DP of the cellulose obtained after work-up (degraded cellulose) does not drop below the “level-off DP” (LODP). The LODP appears to be related to the size of the crystalline regions of the cellulose used. It is dependent on the cellulose used and also on the reaction medium if, for example, solvents such as dimethyl sulfoxide, water, alcohols or methyl ethyl ketone are additionally added. In this method, the yield of degraded cellulose is low because the amorphous regions and the accessible regions of the cellulose are hydrolyzed completely.

Furthermore, it is also possible to subject cellulose to acidic degradation in a homogeneous system. Here, cellulose is, for example, dissolved in a mixture of LiCl/dimethylformamide and treated with an acid. In this method, the preparation of the solution is very costly, the work-up is complicated and the yield of degraded cellulose is low.

In the alkaline degradation of cellulose, glucose units are split off stepwise at the reducing end of the cellulose. This leads to low yields of degraded cellulose.

The oxidative degradation of cellulose is generally carried out by means of oxygen. It normally comprises the formation of individual anhydroglucose units as initial step, and these react further to form unstable intermediates and finally lead to chain rupture. The control of this reaction is generally difficult.

In the case of degradation by means of radiation, cellulose can be treated with high-energy radiation, for example X-rays. Here, the DP of the cellulose is reduced very rapidly. However, chemical modification of the cellulose also occurs, with a large number of carboxylic acid or keto functions being formed. On the other hand, if radiation having lower energy, for example UV/visible light, is used, it is necessary to use photosensitizers. Here too, modification of the cellulose occurs by formation of keto functions or, if oxygen is present during irradiation, peroxide formation occurs.

In the case of thermal treatment, uncontrolled degradation takes place and, in addition, the cellulose is modified; in particular, dehydrocelluloses can be formed.

The abovementioned methods thus have various disadvantages and there is therefore a need to provide a simplified process for the degradation of cellulose which is effected without modification of the polymer and with high yields.

A process for the degradation of cellulose which comprises dissolving cellulose in an ionic liquid and treating this solution at elevated temperatures, if appropriate in the presence of water has now been found.

For the purposes of the present invention, ionic liquids are preferably

(A) salts of the general formula (I)

[A]⁺ₙ[Y]ⁿ⁻ (I),
where n is 1, 2, 3 or 4, [A]⁺ is a quaternary ammonium cation, an oxonium cation, a sulfonium cation or a phosphonium cation and [Y]ⁿ⁻ is a monovalent, divalent, trivalent or tetravalent anion;

(B) mixed salts of the general formulae (II)

[A¹]⁺[A²]⁺[Y]ⁿ⁻ (IIa), where n=2;

[A¹]⁺[A²]⁺[A³]⁺[Y]ⁿ⁻ (IIb), where n=3; or

[A¹]⁺[A²]⁺[A³]⁺[A⁴]⁺[Y]ⁿ⁻ (IIc), where n=4, and
[A¹]⁺, [A²]⁺, [A³]⁺ and [A⁴]⁺ are selected independently from among the groups specified for [A]⁺ and [Y]ⁿ⁻ has the meaning given under (A).

The ionic liquids preferably have a melting point below 180° C. The melting point is particularly preferably in the range from −50° C. to 150° C., in particular in the range from −20° C. to 120° C. and extraordinarily preferably below 100° C.

Compounds which are suitable for forming the cation [A]⁺ of ionic liquids are known, for example, from DE 102 02 838 A1. Thus, such compounds can comprise oxygen, phosphorus, sulfur, or in particular nitrogen atoms, for example at least one nitrogen atom, preferably from 1 to 10 nitrogen atoms, particularly preferably from 1 to 5 nitrogen atoms, very particularly preferably from 1 to 3 nitrogen atoms and in particular 1 or 2 nitrogen atoms. If appropriate, further heteroatoms such as oxygen, sulfur or phosphorus atoms can also be comprised. The nitrogen atom is a suitable carrier of the positive charge in the cation of the ionic liquid from which a proton or an alkyl radical can then be transferred in equlibrium to the anion in order to produce an electrically neutral molecule.

If the nitrogen atom is the carrier of the positive charge in the cation of the ionic liquid, a cation can firstly be produced by quaternization of the nitrogen atom of, for instance, an amine or nitrogen heterocycle in the synthesis of the ionic liquids. Quaternization can be effected by alkylation of the nitrogen atom. Depending on the alkylating reagent used, salts having different anions are obained. In cases in which it is not possible to form the desired anion in the quaternization, this can be effected in a further step of the synthesis. Starting from, for example, an ammonium halide, the halide can be reacted with a Lewis acid to form a complex anion from halide and Lewis acid. A possible alternative thereto is replacement of a halide ion by the desired anion. This can be achieved by addition of a metal salt to precipitate the metal halide formed, by means of an ion exchanger or by displacement of the halide ion by a strong acid (with liberation of the hydrogen halide). Suitable processes are, for example, described in Angew. Chem. 2000, 112, pp. 3926-3945, and the references cited therein.

Suitable alkyl radicals by means of which the nitrogen atom in the amines or nitrogen heterocycles can, for example, be quaternized are C₁-C₁₈-alkyl, preferably C₁-C₁₀-alkyl, particularly preferably C₁-C₆-alkyl and very particularly preferably methyl. The alkyl group can be unsubstituted or have one or more identical or different substituents.

Preference is given to compounds which comprise at least one five- or six-membered heterocycle, in particular a five-membered heterocycle, which has at least one nitrogen atom and also, if appropriate, an oxygen or sulfur atom. Particular preference is likewise given to compounds which comprise at least one five- or six-membered heterocycle which has one, two or three nitrogen atoms and a sulfur atom or an oxygen atom, very particularly preferably ones having two nitrogen atoms. Further preference is given to aromatic heterocycles.

Particularly preferred compounds are ones which have a molecular weight of less than 1000 g/mol, very particularly preferably less than 500 g/mol and in particular less than 350 g/mol.

Furthermore, preference is given to cations selected from among the compounds of the formulae (IIIa) to (IIIw),

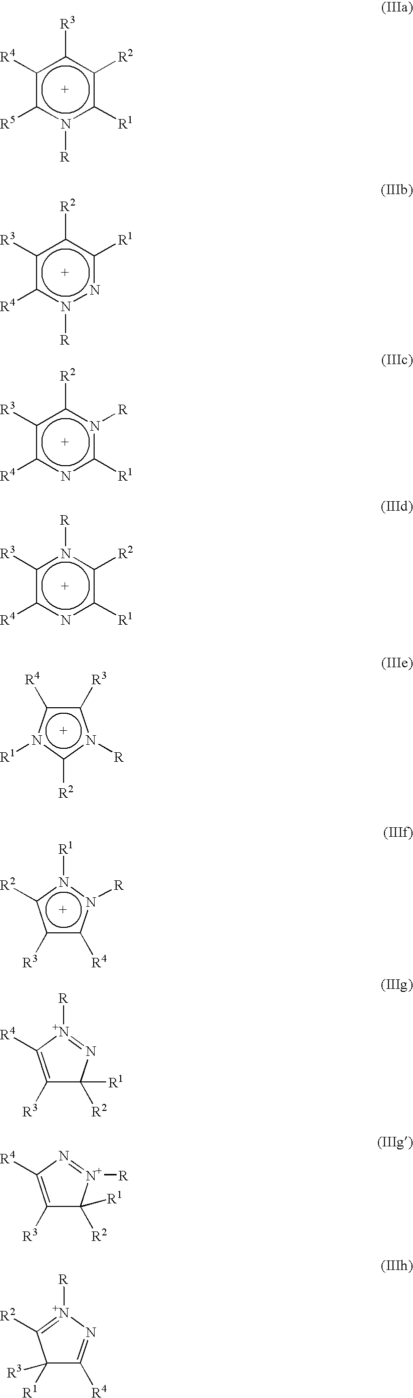

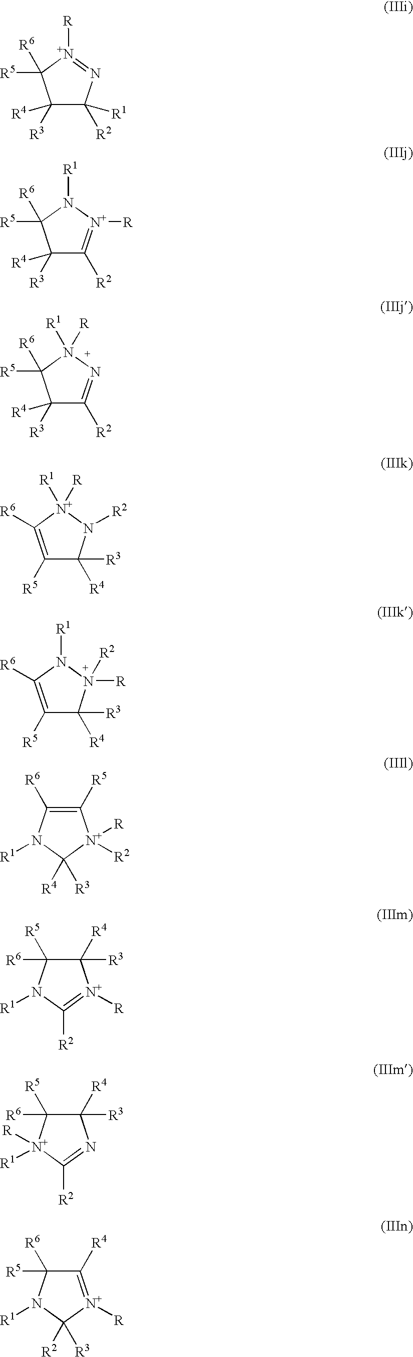

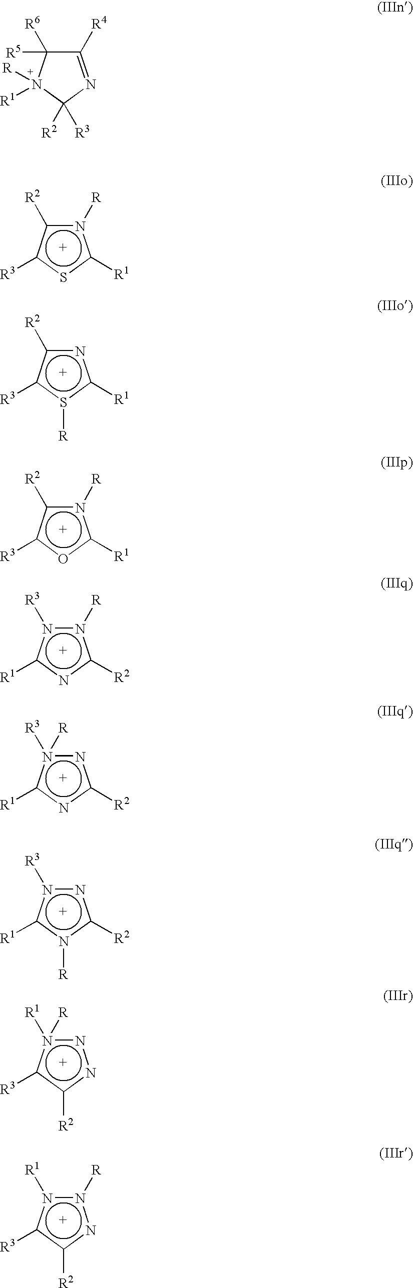

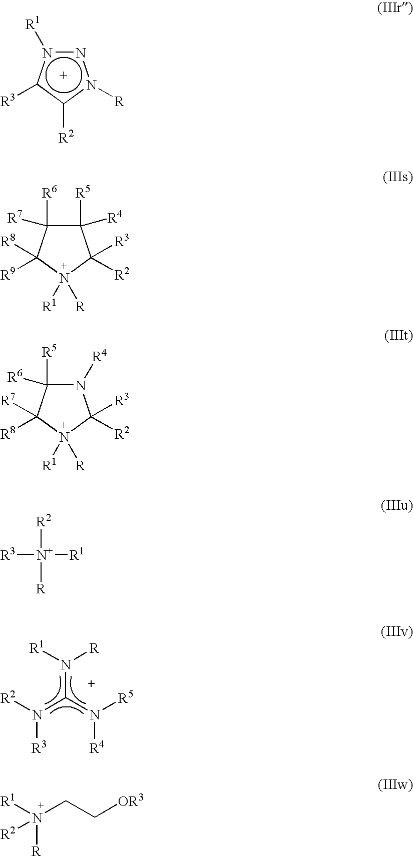

and oligomers comprising these structures.

Further suitable cations are compounds of the general formulae (IIIx) and (IIIy)

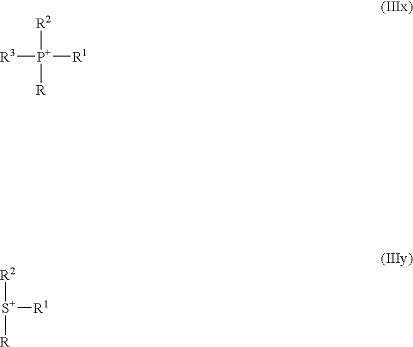

and also oligomers comprising these structures.

In the above formulae (IIIa) to (IIIy),

the radical R is hydrogen or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups; and

the radicals R¹ to R⁹ are each, independently of one another, hydrogen, a sulfo group or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups, where the radicals R¹ to R⁹ which are bound to a carbon atom (and not to a heteroatom) in the abovementioned formulae (III) can additionally be halogen or a functional group; or

two adjacent radicals from the group consisting of R¹ to R⁹ may together also form a divalent, carbon-comprising organic, saturated or unsaturated, acyclic or cyclic, aliphatic, aromatic or araliphatic radical which has from 1 to 30 carbon atoms and may be unsubstituted or be interrupted or substituted by from 1 to 5 heteroatoms or functional groups.

In the definitions of the radicals R and R¹ to R⁹, possible heteroatoms are in principle all heteroatoms which are able to formally replace a —CH₂—group, a —CH═ group, a ═C≡ group or a ═C═group. If the carbon-comprising radical comprises heteroatoms, then oxygen, nitrogen, sulfur, phosphorus and silicon are preferred. Preferred groups are, in particular, —O—, —S—, —SO—, —SO₂—, —NR′—, —N═, —PR′—, —PR′₃ and —SiR′₂—, where the radicals R′ are the remaining part of the carbon-comprising radical. In the cases in which the radicals R¹ to R⁹ are bound to a carbon atom (and not a heteroatom) in the abovementioned formula (I), they can also be bound directly via the heteroatom.

Suitable functional groups are in principle all functional groups which can be bound to a carbon atom or a heteroatom. Suitable examples are —OH (hydroxy), ═O (in particular as carbonyl group), —NH₂ (amino), —NHR′, —NHR₂′, ═NH (imino), NR′, —COOH (carboxy), —CONH₂ (carboxamide), —SO₃H (sulfo) and —CN (cyano). Functional groups and heteroatoms can also be directly adjacent, so that combinations of a plurality of adjacent atoms, for instance —O— (ether), —S— (thioether), —COO— (ester), —CONH— (secondary amide) or —CONR′— (tertiary amide), are also comprised, for example di-(C₁-C₄-alkyl)amino, C₁-C₄-alkyloxycarbonyl or C₁-C₄-alkyloxy. The radicals R′ are the remaining part of the carbon-comprising radical.

As halogens, mention may be made of fluorine, chlorine, bromine and iodine.

The radical R is preferably

unbranched or branched C₁-C₁₈-alkyl which may be unsubstituted or substituted by one or more hydroxy, halogen, phenyl, cyano, C₁-C₆-alkoxycarbonyl and/or SO₃H and has a total of from 1 to 20 carbon atoms, for example methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl- 1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, 2-hydroxyethyl, benzyl, 3-phenylpropyl, 2-cyanoethyl, 2-(methoxycarbonyl)ethyl, 2-(ethoxycarbonyl)ethyl, 2-(n-butoxycarbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluorisopentyl, 6-hydroxyhexyl and propylsulfonic acid;

glycols, butylene glycols and oligomers thereof having from 1 to 100 units and a hydrogen or a C₁-C₈-alkyl as end group, for example R^{A}O—(CHR^{B}—CH₂—O)ₘ—CHR^{B}—CH₂— or R^{A}O—(CH₂CH₂CH₂CH₂O)ₘ—CH₂CH₂CH₂CH₂— where R^{A} and R^{B} are each preferably hydrogen, methyl or ethyl and m is preferably from 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxatridecyl and 3,6,9,12-tetraoxatetradecyl;

vinyl;

1-propen-1-yl, 1-propen-2-yl and 1-propen-3-yl; and

N,N-di-C₁-C₆-alkylamino such as N,N-dimethylamino and N,N-diethylamino.

The radical R is particularly preferably unbranched and unsubstituted C₁-C₁₈-alkyl, such as methyl, ethyl, 1-propyl, 1-butyl, 1-pentyl, 1-hexyl, 1-heptyl, 1-octyl, 1-decyl, 1-dodecyl, 1-tetradecyl, 1-hexadecyl, 1-octadecyl, 1-propen-3-yl, in particular methyl, ethyl, 1-butyl and 1-octyl or CH₃O—(CH₂CH₂O)ₘ—CH₂CH₂—and CH₃CH₂O—(CH₂CH₂O)ₘ—CH₂CH₂— where m is from 0 to 3.

Preference is given to the radicals R¹ to R⁹ each being, independently of one another,

hydrogen;

halogen;

a functional group;

C₁-C₁₈-alkyl which may optionally be substituted by functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups;

C₂-C₁₈-alkenyl, which may optionally be substituted by functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups;

C₆-C₁₂-aryl which may optionally be substituted by functional groups, aryl, alkyl, aryloxy, alkyloxy, halogen, heteroatoms and/or heterocycles;

C₅-C₁₂-cycloalkyl which may optionally be substituted by functional groups, aryl, alkyl, aryloxy, alkyloxy, halogen, heteroatoms and/or heterocycles;

C₅-C₁₂-cycloalkenyl which may optionally be substituted by functional groups, aryl, alkyl, aryloxy, alkyloxy, halogen, heteroatoms and/or heterocycles; or

a five- or six-membered, oxygen-, nitrogen- and/or sulfur-comprising heterocycle which may optionally be substituted by functional groups, aryl, alkyl, aryloxy, alkyloxy, halogen, heteroatoms and/or heterocycles; or two adjacent radicals together form

an unsaturated, saturated or aromatic ring which may optionally be substituted by functional groups, aryl, alkyl, aryloxy, alkyloxy, halogen, heteroatoms and/or heterocycles and may optionally be interrupted by one or more oxygen and/or sulfur atoms and/or one or more substituted or unsubstituted imino groups.

C₁-C₁₈-alkyl which may optionally be substituted by functional groups, aryl, alkyl, aryloxy, alkyloxy, halogen, heteroatoms and/or heterocycles is preferably methyl, ethyl, 1-propyl, 2-propyl, 1-butyl, 2-butyl, 2-methyl-1-propyl (isobutyl), 2-methyl- 2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethylpentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl, cyclopentylmethyl, 2-cyclopentylethyl, 3-cyclopentylpropyl, cyclohexylmethyl, 2-cyclohexylethyl, 3-cyclohexylpropyl, benzyl (phenylmethyl), diphenylmethyl (benzhydryl), triphenylmethyl, 1-phenylethyl, 2-phenylethyl, 3-phenylpropyl, α,α-dimethylbenzyl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonyl- ethyl, 2-ethoxycarbonylethyl, 2-butoxycarbonylpropyl, 1,2-di-(methoxycarbonyl)ethyl, methoxy, ethoxy, formyl, 1,3-dioxolan-2-yl, 1,3-dioxan-2-yl, 2-methyl-1,3-dioxolan-2-yl, 4-methyl-1,3-dioxolan-2-yl, 2-hydroxyethyl, 2-hydroxypropyl, 3-hydroxypropyl, 4-hydroxybutyl, 6-hydroxyhexyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl, 6-ethoxyhexyl, acetyl, CₘF_{2(m-a)+(1-b)}H_{2a+b} where m is from 1 to 30, 0≦a≦m and b=0 or 1 (for example CF₃, C₂F₅, CH2CH₂—C₍ₘ₋₂₎F₂₍ₘ₋₂₎₊₁, C₆F₁₃, C₈F₁₇, C₁₀F₂₁, C₁₂F₂₅), chloromethyl, 2-chloroethyl, trichloromethyl, 1,1-dimethyl-2-chloroethyl, methoxymethyl, 2-butoxyethyl, diethoxymethyl, diethoxyethyl, 2-isopropoxyethyl, 2-butoxypropyl, 2-octyloxyethyl, 2-methoxyisopropyl, 2-(methoxycarbonyl)ethyl, 2-(ethoxycarbonyl)ethyl, 2-(n-butoxycarbonyl)ethyl, butylthiomethyl, 2-dodecylthioethyl, 2-phenylthioethyl, 5-hydroxy-3-oxapentyl, 8-hydroxy-3,6-dioxaoctyl, 11-hyd roxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-Hydroxy-5,10-dioxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-dioxatetradecyl, 5-ethoxy-3-oxapentyl, 8-ethoxy-3,6-dioxaoctyl, 11-ethoxy-3, 6, 9-trioxaundecyl, 7-ethoxy-4-oxaheptyl, 11-ethoxy-4, 8-dioxaundecyl, 15-ethoxy-4,8, 12-trioxapentadecyl, 9-ethoxy-5-oxanonyl or 14-ethoxy-5,10-oxatetradecyl.

C₂-C₁₈-Alkenyl which may optionally be substituted by functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups is preferably vinyl, 2-propenyl, 3-butenyl, cis-2-butenyl, trans-2-butenyl or CₘF_{2(m-a)-(1-b)}H_{2a-b} where m≦30, 0≦a≦m and b=0 or 1.

C₆-C₁₂-aryl which may optionally be substituted by functional groups, aryl, alkyl, aryloxy, alkyloxy, halogen, heteroatoms and/or heterocycles is preferably phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methyinaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2-nitrophenyl, 4-nitrophenyl, 2,4-dinitrophenyl, 2,6-dinitrophenyl, 4-dimethylaminophenyl, 4-acetylphenyl, methoxyethylphenyl, ethoxymethylphenyl, methylthiophenyl, isopropylthiophenyl or tert-butylthiophenyl or C₆F₍₅₋ₐ₎Hₐ where 0≦a≦5.

C₅-C₁₂-cycloalkyl which may optionally be substituted by functional groups, aryl, alkyl, aryloxy, alkyloxy, halogen, heteroatoms and/or heterocycles is preferably cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl, CₘF_{2(m-a)-(1-b)}H_{2a-b} where m≦30, 0≦a≦m and b=0 or 1, or a saturated or unsaturated bicyclic system such as norbornyl or norbornenyl.

C₅- to C₁₂-cycloalkenyl which may optionally be substituted by functional groups, aryl, alkyl, aryloxy, alkyloxy, halogen, heteroatoms and/or heterocycles is preferably 3-cyclopentenyl, 2-cyclohexenyl, 3-cyclohexenyl, 2,5-cyclohexadienyl or CₙF_{2(m-a)-3(1-b)}H_{2a-3b} where m≦30, 0≦a≦m and b=0 or 1.

A five- or six-membered, oxygen-, nitrogen- and/or sulfur-comprising heterocycle which may optionally be substituted by functional groups, aryl, alkyl, aryloxy, alkyloxy, halogen, heteroatoms and/or heterocycles is preferably furyl, thiophenyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl or difluoropyridyl.

If two adjacent radicals together form an unsaturated, saturated or aromatic ring which may optionally be substituted by functional groups, aryl, alkyl, aryloxy, alkyloxy, halogen, heteroatoms and/or heterocycles and may optionally be interrupted by one or more oxygen and/or sulfur atoms and/or one or more substituted or unsubstituted imino groups, they preferably form 1,3-propylene, 1,4-butylene, 1,5-pentylene, 2-oxa-1,3-propylene, 1-oxa-1,3-propylene, 2-oxa-1,3-propylene, 1-oxo-1,3-propenylene, 3-oxa-1,5-pentylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

If the abovementioned radicals comprise oxygen and/or sulfur atoms and/or substituted or unsubstituted imino groups, the number of oxygen and/or sulfur atoms and/or imino groups is not subject to any restrictions. In general, there will be no more than 5 in the radical, preferably no more than 4 and very particularly preferably no more than 3.

If the abovementioned radicals comprise heteroatoms, there is generally at least one carbon atom, preferably at least two carbon atoms, between any two heteroatoms.

Particular preference is given to the radicals R¹ to R⁹ each being, independently of one another,

hydrogen;

unbranched or branched C₁-C₁₈-alkyl which may be unsubstituted or substituted by one or more hydroxy, halogen, phenyl, cyano, C₁-C₆-alkylcarbonyl and/or SO₃H and has a total of from 1 to 20 carbon atoms, for example methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2, 2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, 2-hydroxyethyl, benzyl, 3-phenylpropyl, 2-cyanoethyl, 2-(methoxycarbonyl)ethyl, 2-(ethoxycarbonyl)ethyl, 2-(n-butoxy-carbonyl) ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl, 6-hydroxyhexyl and propylsulfonic acid;

glycols, butylene glycols and oligomers thereof having from 1 to 100 units and a hydrogen or a C₁-C₈-alkyl as end group, for example R^{A}O—(CHR^{B}—CH₂—O)ₘ—CHR^{B}—CH₂— or R^{A}O—(CH₂CH₂CH₂CH₂O)ₘ—CH₂CH₂CH₂CH₂— where R^{A} and R^{B} are each preferably hydrogen, methyl or ethyl and n is preferably from 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxatridecyl and 3,6,9,12-tetraoxatetrad ecyl;

vinyl;

1-propen-1-yl, 1-propen-2-yl and 1-propen-3-yl; and

N,N-di-C₁-C₆-alkylamino, such as N,N-dimethylamino and N,N-diethylamino. Very particular preference is given to the radicals R¹ to R⁹ each being, independently of one another, hydrogen or C₁-C₁₈-alkyl such as methyl, ethyl, 1-butyl, 1-pentyl, 1-hexyl, 1-heptyl, 1-octyl, phenyl, 2-hydroxyethyl, 2-cyanoethyl, 2-(methoxy-carbonyl) ethyl, 2-(ethoxycarbonyl)ethyl, 2-(n-butoxycarbonyl)ethyl, N,N-dimethylamino, N,N-diethylamino, chlorine or CH₃O—(CH₂CH₂O)ₘ—CH₂CH₂— and CH₃CH₂O—(CH₂CH₂O)ₘ—CH₂CH₂— where m is from 0 to 3.

Very particularly preferred pyridinium ions (IIIa) are those in which

one of the radicals R¹ to R⁵ is methyl, ethyl or chlorine and the remaining radicals R¹ to R⁵ are each hydrogen;

R³ is dimethylamino and the remaining radicals R¹, R², R⁴ and R⁵ are each hydrogen;

all radicals R¹ to R⁵ are hydrogen;

R² is carboxy or carboxamide and the remaining radicals R¹, R², R⁴ and R⁵ are each hydrogen; or

R¹ and R² or R² and R³ are together 1,4-buta-1,3-dienylene and the remaining radicals R¹, R², R⁴ and R⁵ are each hydrogen;

and in particular those in which

R¹ to R⁵ are each hydrogen; or

one of the radicals R¹ to R⁵ is methyl or ethyl and the remaining radicals R¹ to R⁵ are each hydrogen.

As very particularly preferred pyridinium ions (IIIa), mention may be made of 1-methylpyridinium, 1-ethylpyridinium, 1-(1-butyl)pyridinium, 1-(1-hexyl)pyridinium, 1-(1-octyl)pyridinium, 1-(1-hexyl)pyridinium, 1-(1-octyl)pyridinium, 1-(1-dodecyl) pyridinium, 1-(1-tetradecyl)pyridinium, 1-(1-hexadecyl)pyridinium, 1,2-di-methylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium and 1-(1-octyl)-2-methyl-3-ethyl-pyridinium, 1-(1-dodecyl)-2-methyl-3-ethylpyridinium, 1-(1-tetradecyl)-2-methyl-3-ethylpyridinium and 1-(1-hexadecyl)-2-methyl-3-ethyl-pyridinium.

Very particularly preferred pyridazinium ions (IIIb) are those in which

R¹ to R⁴ are each hydrogen; or

one of the radicals R¹ to R⁴ is methyl or ethyl and the remaining radicals R¹ to R⁴ are each hydrogen.

Very particularly preferred pyrimidinium ions (IIIc) are those in which

R¹ is hydrogen, methyl or ethyl and R² to R⁴ are each, independently of one another, hydrogen or methyl; or

R¹ is hydrogen, methyl or ethyl, R² and R⁴ are each methyl and R³ is hydrogen.

Very particularly preferred pyrazinium ions (IIId) are those in which

R¹ is hydrogen, methyl or ethyl and R² to R⁴ are each, independently of one another, hydrogen or methyl;

R¹ is hydrogen, methyl or ethyl, R² and R⁴ are each methyl and R³ is hydrogen;

R¹ to R⁴ are each methyl; or

R¹ to R⁴ are each methyl or hydrogen.

Very particularly preferred imidazolium ions (IIIe) are those in which

R¹ is hydrogen, methyl, ethyl, 1-propyl, 1-butyl, 1-pentyl, 1-hexyl, 1-octyl, 1-propen-3-yl, 2-hydroxyethyl or 2-cyanoethyl and R² to R⁴ are each, independently of one another, hydrogen, methyl or ethyl.

As very particularly preferred imidazolium ions (IIIe), mention may be made of 1-methylimidazolium, 1-ethylimidazolium, 1-(1-butyl)imidazolium, 1-(1-octyl) imidazolium, 1-(1-dodecyl)imidazolium, 1-(1-tetradecyl)imidazolium, 1-(1-hexadecyl) imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methyl-imidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butyl-imidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butyl-imidazolium, 1-(1-tetradecyl)-3-octylimidazolium, 1-(1-hexadecyl)-3-methylimidazo-lium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 1,4-dimethyl-3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium, and 1-(prop-1-en-3-yl)-3-methylimidazolium.

Very particularly preferred pyrazolium ions (IIIf), (IIIg) and (IIIg′) are those in which

R¹ is hydrogen, methyl or ethyl and R² to R⁴ are each, independently of one another, hydrogen or methyl.

Very particularly preferred pyrazolium ions (IIIh) are those in which

R¹ to R⁴ are each, independently of one another, hydrogen or methyl. Very particularly preferred 1-pyrazolinium ions (IIIi) are those in which

R¹ to R⁶ are each, independently of one another, hydrogen or methyl. Very particularly preferred 2-pyrazolinium ions (IIIj) and (IIIj′) are those in which

R¹ is hydrogen, methyl, ethyl or phenyl and R² to R⁶ are each, independently of one another, hydrogen or methyl.

Very particularly preferred 3-pyrazolinium ions (IIIk) and (IIIk′) are those in which

R¹ and R² are each, independently of one another, hydrogen, methyl, ethyl or phenyl and R³ to R⁶ are each, independently of one another, hydrogen or methyl.

Very particularly preferred imidazolinium ions (IIIl) are those in which

R¹ and R² are each, independently of one another, hydrogen, methyl, ethyl, 1-butyl or phenyl, R³ and R⁴ are each, independently of one another, hydrogen, methyl or ethyl and R⁵ and R⁶ are each, independently of one another, hydrogen or methyl.

Very particularly preferred imidazolinium ions (IIIm) and (IIIm′) are those in which

R¹ and R² are each, independently of one another, hydrogen, methyl or ethyl and R³ to R⁶ are each, independently of one another, hydrogen or methyl.

Very particularly preferred imidazolinium ions (IIIn) and (IIIn′) are those in which

R¹ to R³ are each, independently of one another, hydrogen, methyl or ethyl and R⁴ to R⁶ are each, independently of one another, hydrogen or methyl.

Very particularly preferred thiazolium ions (IIIo) and (IIIo′) and oxazolium ions (IIIp) are those in which

R¹ is hydrogen, methyl, ethyl or phenyl and R² and R³ are each, independently of one another, hydrogen or methyl.

Very particularly preferred 1,2,4-triazolium ions (IIIq), (IIIq′) and (IIIq″) are those in which

R¹ and R² are each, independently of one another, hydrogen, methyl, ethyl or phenyl and R³ is hydrogen, methyl or phenyl.

Very particularly preferred 1,2,3-triazolium ions (IIIr), (IIIr′) and (IIIr″) are those in which

R¹ is hydrogen, methyl or ethyl and R² and R³ are each, independently of one another, hydrogen or methyl or R² and R³ are together 1,4-buta-1,3-dienylene.

Very particularly preferred pyrrolidinium ions (IIIs) are those in which

R¹ is hydrogen, methyl, ethyl or phenyl and R² to R⁹ are each, independently of one another, hydrogen or methyl. Very particularly preferred imidazolidinium ions (IIIt) are those in which

R¹ and R⁴ are each, independently of one another, hydrogen, methyl, ethyl or phenyl and R² and R³ and also R⁵ to R⁸ are each, independently of one another, hydrogen or methyl.

Very particularly preferred ammonium ions (IIIu) are those in which

R¹ to R³ are each, independently of one another, C₁-C₁₈-alkyl; or

R¹ and R² are together 1,5-pentylene or 3-oxa-1,5-pentylene and R³ is C₁-C₁₈-alkyl, 2-hydroxyethyl or 2-cyanoethyl.

Very particularly preferred ammonium ions (IIIu) are methyltri(1-butyl)ammonium, N,N-dimethylpiperidinium and N,N-dimethylmorpholinium.

Examples of tertiary amines from which the quaternary ammonium ions of the general formula (IIIu) can be derived by quaternization by the abovementioned radicals R are diethyl-n-butylamine, diethyl-tert-butylamine, diethyl-n-pentylamine, diethyl-hexylamine, diethyloctylamine, diethyl-(2-ethylhexyl)amine, di-n-propylbutylamine, di-n-propyl-n-pentylamine, di-n-propylhexylamine, di-n-propyloctylamine, di-n-propyl-(2-ethylhexyl)amine, diisopropylethylamine, diiso-propyl-n-propylamine, diisopropylbutylamine, diisopropylpentylamine, diiso-propylhexylamine, diisopropyloctylamine, diisopropyl(2-ethylhexyl)amine, di-n-butylethylamine, di-n-butyl-n-propylamine, di-n-butyl-n-pentylamine, di-n-butylhexylamine, di-n-butyloctylamine, di-n-butyl(2-ethylhexyl)amine, N-n-butyl-pyrrolidine, N-sec-butylpyrrolidine, N-tert-butylpyrrolidine, N-n-pentylpyrrolidine, N,N-dimethylcyclohexylamine, N,N-diethylcyclohexylamine, N,N-di-n-butylcyclo-hexylamine, N-n-propylpiperidine, N-isopropylpiperidine, N-n-butylpiperidine, N-sec-butylpiperidine, N-tert-butylpiperidine, N-n-pentylpiperidine, N-n-butylmorpholine, N-sec-butylmorpholine, N-tert-butylmorpholine, N-n-pentylmorpholine, N-benzyl-N-ethylaniline, N-benzyl-N-n-propylaniline, N-benzyl-N-isopropylaniline, N-benzyl-N-n-butylaniline, N,N-dimethyl-p-toluidine, N,N-diethyl-p-toluidine, N,N-di-n-butyl-p-toluidine, diethylbenzylamine, di-n-propylbenzylamine, di-n-butylbenzylamine, diethylphenylamine, di-n-propylphenylamine and di-n-butylphenylamine.

Preferred tertiary amines (IIIu) are diisopropylethylamine, diethyl-tert-butylamine, di-isopropylbutylamine, di-n-butyl-n-pentylamine, N,N-di-n-butylcyclohexylamine and also tertiary amines derived from pentyl isomers.

Particularly preferred tertiary amines are di-n-butyl-n-pentylamine and tertiary amines derived from pentyl isomers. A further preferred tertiary amine having three identical radicals is triallylamine.

Very particularly preferred guanidinium ions (IIIv) are those in which

R¹ to R⁵ are each methyl.

A very particularly preferred guanidinium ion (IIIv) is N,N,N′,N′,N″,N″-hexamethylguanidinium.

Very particularly preferred cholinium ions (IIIw) are those in which

R¹ and R² are each, independently of one another, methyl, ethyl, 1-butyl or 1-octyl and R³ is hydrogen, methyl, ethyl, acetyl, —SO20H or —PO(OH)₂;

R¹ is methyl, ethyl, 1-butyl or 1-octyl, R² is a —CH₂—CH₂—OR⁴ group and R³ and R⁴ are each, independently of one another, hydrogen, methyl, ethyl, acetyl, —SO₂OH or —PO(OH)₂; or

R¹ is a —CH₂—CH₂—OR⁴ group, R² is a —CH₂—CH₂—OR⁵ group and R³ to R⁵ are each, independently of one another, hydrogen, methyl, ethyl, acetyl, —SO₂OH or —PO(OH)₂.

Particularly preferred cholinium ions (IIIw) are those in which R³ is selected from among hydrogen, methyl, ethyl, acetyl, 5-methoxy-3-oxapentyl, 8-methoxy-3,6-dioxa-octyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxa-tetradecyl.

Very particularly preferred phosphonium ions (Ilix) are those in which

R¹ to R³ are each, independently of one another, C₁-C₁₈-alkyl, in particular butyl, isobutyl, 1-hexyl or 1-octyl.

Among the abovementioned heterocyclic cations, preference is given to the pyridinium ions, pyrazolinium ions, pyrazolium ions and the imidazolinium ions and the imidazolium ions. Preference is also given to ammonium ions.

Particular preference is given to 1-methylpyridinium, 1-ethylpyridinium, 1-(1-butyl)-pyridinium, 1-(1-hexyl)pyridinium, 1-(1-octyl)pyridinium, 1-(1-hexyl)pyridinium, 1-(1-octyl) pyridinium, 1-(1-dodecyl)pyridinium, 1-(1-tetradecyl)pyridinium, 1-(1-hexa-decyl) pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium, 1-(1-octyl)-2-methyl-3-ethylpyridinium, 1-(1-dodecyl)-2-methyl-3-ethylpyridinium, 1-(1-tetradecyl)-2-methyl-3-ethylpyridinium, 1-(1-hexadecyl)-2-methyl-3-ethylpyridinium, 1-methylimidazolium, 1-ethylimidazolium, 1-(1-butyl)-imidazolium, 1-(1-octyl)-imidazolium, 1-(1-dodecyl)-imidazolium, 1-(1-tetra-decyl) imidazolium, 1-(1-hexadecyl)imidazolium, 1,3-dimethylimidazolium, 1-ethyl-3-methylimidazolium, 1-(1-butyl)-3-methylimidazolium, 1-(1-hexyl)-3-methylimidazolium, 1-(1-octyl)-3-methylimidazolium, 1-(1-dodecyl)-3-methylimidazolium, 1-(1-tetradecyl)-3-methylimidazolium, 1-(1-hexadecyl)-3-methylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium and 1-(1-octyl)-2,3-dimethylimidazolium, 1,4-di-methylimidazolium, 1,3,4-trimethylimidazolium, 1,4-dimethyl-3-ethylimidazolium, 1,4-dimethyl-3-butylimidazolium, 1,4-dimethyl-3-octylimidazolium, 1,4,5-trimethyl-imidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium.

As anions, it is in principle possible to use all anions.

The anion [Y]⁻ of the ionic liquid is, for example, selected from among
the group of halides and halogen-comprising compounds of the formulae:
F—, Cl—, Br, I—, BF₄—, PF₆—, CF₃SO₃—, (CF₃SO₃)₂N—, CF₃CO₂—, CCl₃CO₂—, CN—, SCN—, OCN—
the group of sulfates, sulfites and sulfonates of the general formulae: SO₄²—, HSO₄—, SO₃²—, HSO₃—, R^{a}OSO₃—, R^{a}SO₃—
the group of phosphates of the general formulae PO₄³—, HPO₄²—, H₂PO₄—, R^{a}PO₄²—, HR^{a}PO₄—, R^{a}R^{b}PO₄-
the group of phosphonates and phosphinates of the general formulae: R^{a}HPO₃—,R^{a}R^{b}PO₂—, R^{a}R^{b}PO₃-
the group of phosphites of the general formulae: PO₃³—, HP0₃²—, H₂PO₃—, R^{a}PO₃²—, R^{a}HPO₃—, R^{a}R^{b}PO₃—
the group of phosphonites and phosphinites of the general formulae: R^{a}R^{b}PO₂—, R^{a}HPO₂—, R^{a}R^{b}PO—, R^{a}HPO—
the group of carboxylic acids of the general formula: R^{a}COO—
the group of borates of the general formulae: BO₃³—, HBO₃²—, H₂BO₃—, R^{a}R^{b}BO₃—, R^{a}HBO₃—, R^{a}BO₃²—, B(OR^{a})(OR^{b})(OR^{c})(OR^{d})—, B(HSO₄)—, B(R^{a}SO₄)—
the group of boronates of the general formulae: R^{a}BO₂²—, R^{a}R^{b}BO—
the group of silicates and silicic esters of the general formulae:
SiO₄⁴—, HSiO₄³—, H₂SiO₄²—, H₃SiO₄—, R^{a}SiO₄³—, R^{a}R^{b}SiO₄²—, R^{a}R^{b}R^{c}SiO₄—, HR^{a}SiO₄²—, H₂R^{a}SiO₄—, HR^{a}R^{b}SiO₄—
the group of alkylsilane and arylsilane salts of the general formulae: R^{a}SiO₃³—, R^{a}R^{b}SiO₂²—, R^{a}R^{b}R^{c}SiO—, R^{a}R^{b}R^{c}SiO₃—, R^{a}R^{b}R^{c}SiO₂—, R^{a}R^{b}SiO₃²—
the group of carboximides, bis(sulfonyl)imides and sulfonylimides of the general formulae:

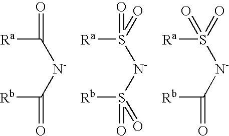

the group of methides of the general formula:

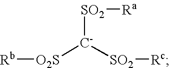

here, R^{a}, R^{b}, R^{c} and R^{d} are each, independently of one another, hydrogen, C₁-C₃₀-alkyl, C₂-C₁₈-alkyl which may optionally be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogen- and/or sulfur-comprising heterocycle, where two of them may together form an unsaturated, saturated or aromatic ring which may optionally be interrupted by one or more oxygen and/or sulfur atoms and/or one or more unsubstituted or substituted imino groups, where the radicals mentioned may each be additionally substituted by functional groups, aryl, alkyl, aryloxy, alkyloxy, halogen, heteroatoms and/or heterocycles.

Here, C₁-C₁₈-alkyl which may optionally be substituted by functional groups, aryl, alkyl, aryloxy, alkyloxy, halogen, heteroatoms and/or heterocycles is, for example, methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hetadecyl, octadecyl, 1,1-dimethylpropyl, 1,1-dimethylbutyl, 1,1,3,3-tetramethylbutyl, benzyl, 1-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonethyl, 2-ethoxycarbonylethyl, 2-butoxy-carbonylpropyl, 1,2-di-(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 4-aminobutyl, 6-aminohexyl, 2-methylaminoethyl, 2-methylaminopropyl, 3-methylaminopropyl, 4-methylaminobutyl, 6-methyl-aminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxy-hexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl.

C₂-C₁₈-Alkyl which may optionally be interrupted by one or more nonadjacent oxygen and/or sulfur atoms and/or one or more substituted or unsubstituted imino groups is, for example, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl,11-methoxy-3,6,9-trioxaundecyl, 7-methoxy-4-oxaheptyl,11-methoxy-4,8-dioxaundecyl, 15-methoxy-4,8,12-trioxa-pentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

If two radicals form a ring, these radicals can together form as fused-on building block, for example, 1,3-propylene, 1,4-butylene, 2-oxa-1,3-propylene, 1-oxa-1,3-propylene, 2-oxa-1,3-propenylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

The number of nonadjacent oxygen and/or sulfur atoms and/or imino groups is in principle not subject to any restrictions or is automatically restricted by the size of the radical or the cyclic building block. In general, there will be no more than 5 in the respective radical, preferably no more than 4 and very particularly preferably no more than 3. Furthermore, there is generally at least one carbon atom, preferably at least two carbon atoms, between any two heteroatoms.

Substituted and unsubstituted imino groups can be, for example, imino, methylimino, isopropylimino, n-butylimino or tert-butylimino.

For the purposes of the present invention, the term “functional groups” refers, for example, to the following: carboxy, carboxamide, hydroxy, di-(C₁-C₄-alkyl)amino, C₁-C₄-alkyloxycarbonyl, cyano or C₁-C₄-alkoxy. Here, C₁ to C₄-alkyl is methyl, ethyl, propyl, isopropyl, n-butyl, sec-butyl or tert-butyl.

C₆-C₁₄-Aryl which may optionally be substituted by functional groups, aryl, alkyl, aryloxy, alkyloxy, halogen, heteroatoms and/or heterocycles is, for example, phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethyl-phenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl.

C₅-C₁₂-Cycloalkyl which may optionally be substituted by functional groups, aryl, alkyl, aryloxy, halogen, heteroatoms and/or heterocycles is, for example, cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl.

A five- or six-membered, oxygen-, nitrogen- and/or sulfur-comprising heterocycle is, for example, furyl , thiophenyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl, difluoropyridyl, methylthiophenyl, isopropylthiophenyl or tert-butylthiophenyl.

Preferred anions are selected from the group of halides and halogen-comprising compounds, the group of carboxylic acids, the group of sulfates, sulfites and sulfonates and the group of phosphates, in particular from the group of halides and halogen-comprising compounds, the group of carboxylic acids, the group consisting of SO₄²—, SO₃²—, R^{a}OSO₃— and R^{a}SO₃—, and the group consisting of PO₄³— and R^{a}R^{b}PO₄—.

Preferred anions are chloride, bromide, iodide, SCN—, OCN—, CN—, acetate, C₁-C₄-alkylsulfates, R^{a}—COO—, R^{a}SO₃—, R^{a}R^{b}PO₄—, methanesulfonate, tosylate or C₁-C₄-dialkylphosphates.

Particularly preferred anions are Cl—, CH₃COO—, C₂H₅COO—, C₈H₅COO—, CH₃SO₃—, (CH₃O)₂PO₂— or (C₂H₅O)₂PO₂—.

In a further preferred embodiment, use is made of ionic liquids of the formula I in which

[A]ₙ⁺ is 1-methylimidazolium, 1-ethylimidazolium, 1-(1-butyl)imidazolium, 1-(1-octyl)-imidazolium, 1-(1-dodecyl)imidazolium, 1-(1-tetradecyl)imidazolium, 1-(1-hexadecyl) imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butyl-imidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethyl-imidazolium, 1,4-dimethyl-3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octyl-imidazolium or 1-(prop-1-en-3-yl)-3-methylimidazolium; and

[Y]ⁿ⁺ is Cl—, CH₃COO—, C₂H₅COO—, C₆H₅COO—, CH₃SO₃—, (CH₃O)₂PO₂— or (C₂H₅O)₂PO₂—.

In a further preferred embodiment, use is made of ionic liquids whose anions are selected from the group consisting of HSO₄—, HPO₄²—, H₂PO₄— and HR^{a}PO₄—; in particular HSO₄—.

In particular, use is made of ionic liquids of the formula I in which

[A]ₙ⁺ is 1-methylimidazolium, 1-ethylimidazolium, 1-(1-butyl)imidazolium, 1-(1-octyl)-imidazolium, 1-(1-dodecyl)imidazolium, 1-(1-tetradecyl)imidazolium, 1-(1-hexadecyl) imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butyl-imidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethyl-imidazolium, 1,4-dimethyl-3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octyl-imidazolium or 1-(prop-1-en-3-yl)-3-methylimidazolium; and

[Y]ⁿ⁺ is HSO₄—.

In the process of the invention, an ionic liquid of the formula I or a mixture of ionic liquids of the formula I is used; preference is given to using an ionic liquid of the formula I.

In a further embodiment of the invention, it is possible to use an ionic liquid of the formula II or a mixture of ionic liquids of the formula II; preference is given to using an ionic liquid of the formula II.

In a further embodiment of the invention, it is possible to use a mixture of ionic liquids of the formulae I and II.

The degradation according to the invention of cellulose can be carried out using celluloses from a wide variety of sources, e.g. from cotton, flax, ramie, straw, bacteria, etc., or from wood or bagasse, in the cellulose-enriched form.

However, the process of the invention can be used not only for the degradation of cellulose but generally for the cleavage or degradation of polysaccharides, oligosaccharides and disaccharides and also derivatives thereof. Examples of polysaccharides are, in addition to cellulose and hemicellulose, starch, glycogen, dextran and tunicin. Polysaccharides likewise include the polycondensates of D-fructose, e.g. inulin, and also, inter alia, chitin and alginic acid. Sucrose is an example of a disaccharide. Possible cellulose derivatives are, inter alia, cellulose ethers such as methylcellulose and carboxymethylcellulose, cellulose esters such as cellulose acetate, cellulose butyrate and cellulose nitrate. The relevant statements made above apply analogously.

In the process of the invention, a solution of cellulose in an ionic liquid is prepared. The concentration of cellulose can here be varied within a wide range. It is usually in the range from 0.1 to 50% by weight, based on the total weight of the solution, preferably from 0.2 to 40% by weight, particularly preferably from 0.3 to 30% by weight and very particularly preferably from 0.5 to 20% by weight.

This dissolution process can be carried out at room temperature or with heating, but above the melting point or softening temperature of the ionic liquid, usually at a temperature of from 0 to 150° C., preferably from 20 to 150° C., particularly preferably from 50 to 150° C. However, it is also possible to accelerate the dissolution process by intensive stirring or mixing and by introduction of microwave energy or ultrasonic energy or by means of a combination of these.

The degradation is, depending on the ionic liquid used, usually carried out at a temperature in the range from the melting point of the ionic liquid of from 0 to 200° C., preferably from 20 to 180° C., in particular from 50 to 150° C.

If ionic liquids which have acid functions are used, then it is possible to reduce the reaction temperature. Possible ionic liquids here are, in particular, ones whose anions are selected from the group consisting of HSO₄—, HPO₄²—, H₂PO₄— and HR^{a}PO₄; in particular HSO₄—. Reactions in these ionic liquids are preferably carried out at a temperature of from 0 to 150° C., preferably from 20 to 150° C., in particular from 50 to 150° C.

If ionic liquids which do not have any acid functions are used, then the reaction is usually carried out at from 50 to 200° C., preferably from 80° C. to 180° C., in particular from 80 to 150° C. Possible ionic liquids here are ones whose anions are selected from the group of halides and halogen-comprising compounds, the group of carboxylic acids, the group consisting of SO₄2—, SO₃2—, R^{a}OSO₃— and R^{a}SO₃— and also the group consisting of PO₄³— and R^{a}R^{b}PO₄—. Preferred anions here are chloride, bromide, iodide, SCN—, OCN—, CN—, acetate, C₁-C₄ alkylsulfate, R^{a}—COO—, R^{a}SO₃—, R^{a}R^{b}PO₄—, methansulfonate, tosylate and C₁-C₄-dialkylphosphate; and particularly preferred anions are Cl—, CH₃COO—, C₂H₅COO—, C₆H₅COO—, CH₃SO₃—, (CH₃O)₂PO₂— and (C₂H₅O)₂PO₂—.

In one embodiment, the preparation of the reaction solution and the degradation are carried out at the same temperature.

In a further embodiment, the preparation of the reaction solution and the degradation are carried out at different temperatures.

It is sometimes also possible for degradation of the cellulose to take place during the preparation of the reaction solution. In a specific embodiment, the dissolution process and the degradation process occur effectively in parallel.

The reaction is usually carried out at ambient pressure. However, it can also be advantageous, on a case-to-case basis, to work under superatmospheric pressure.

In general, the reaction is carried out in air. However, it is also possible to work under inert gas, i.e., for example, under N₂, a noble gas, CO₂ or mixtures thereof.

The reaction time and the reaction temperature are set as a function of the desired degree of degradation.

In one embodiment, water is added. By using an excess of water based on the anhydroglucose units of the cellulose, complete degradation as far as glucose can also be achieved. In the case of partial degradation of the cellulose, substoichiometric amounts of water are preferably added, or the reaction is stopped.

If the degradation is carried out in the presence of water, it is possible to premix the ionic liquid and the water, and to dissolve the cellulose in this mixture. However, it is also possible to add the water to the solution of ionic liquid and cellulose.

If, for example, the cellulose which is on average made up of x anhydroglucose units is to be degraded completely to glucose, then x equivalents of water are required. Here, preference is given to using the stoichiometric amount of water (n_{anhydroglucose units}/n_{water}=1) or an excess. However, the excess of water must not be so high that the solubility of the cellulose is no longer ensured. An excess of at least 3 mol %, but at most 3000 mol % of water based on x is used.

If the cellulose which is on average made up of x anhydroglucose units is to be converted into a cellulose whose number of anhydroglucose units is less than x, the amount of water used is usually adapted accordingly (n_{anhydroglucose units}/n_{water}>1). The larger the ratio of n_{anhydroglucose units}/n_{water}, the lower the average degradation of cellulose under otherwise identical reaction conditions and identical reaction time and the higher the DP of the degraded cellulose (which is of course less than the DP of the cellulose used).

In another embodiment, the process is carried out without addition of water. This is generally the case when the ionic liquid used comprises small amounts of water and/or when water adheres to the cellulose used. The proportion of water in customary cellulose can be up to 10% by weight, based on the total weight of the cellulose used. What has been said above applies analogously.

There is also the possibility of adding one or more further solvents to the reaction mixture or the water, if this was added. Solvents which may be mentioned are those which do not adversely affect the solubility of the cellulose, such as aprotic dipolar solvents, for example dimethyl sulfoxide, dimethylformamide, dimethylacetamide or sulfolane.

In one particular embodiment, the reaction mixture comprises less than 5% by weight, preferably less than 2% by weight, in particular less than 0.1% by weight of further solvents, based on the total weight of the reaction mixture.

Furthermore, it is possible to stop the degradation reaction when the desired degree of degradation has been reached by separating off the cellulose from the reaction mixture. This can be effected, for example, by addition of an excess of water, in general at least 20% by weight based on the cellulose solution or another suitable solvent in which the degraded cellulose is not soluble, e.g. a lower alcohol such as methanol, ethanol, propanol or butanol, or a ketone, for example acetone, etc., or mixtures thereof. Preference is given to using an excess of water or methanol.

The reaction mixture is usually worked up by precipitating the cellulose as described above and filtering off the cellulose. The ionic liquid can be recovered from the filtrate using customary methods, by distilling off the volatile components such as the precipitant, the water. The ionic liquid which remains can be reused in the process of the invention.

Owing to the random degradation of the cellulose, the ionic liquid to be regenerated comprises only little glucose or its oligomers. Any amounts of these compounds present can be separated off from the ionic liquid by extraction with a solvent or by addition of a precipitant.

It is also possible to stop the degradation reaction when the desired degree of degradation has been reached by precipitating the cellulose from the reaction mixture, without the reaction mixture having been cooled beforehand.

It is also possible to introduce the reaction mixture into water or into another suitable solvent in which the degraded cellulose is not soluble, e.g. a lower alcohol such as methanol, ethanol, propanol or butanol or a ketone, for example acetone, etc., or mixtures thereof and, depending on the embodiment, obtain, for example fibers, films etc. of degraded cellulose. The filtrate is worked up as described above.

If reaction conditions under which the cellulose is degraded completely are chosen, the corresponding glucose can be separated off from the ionic liquid by customary methods, e.g. precipitation with ethanol.

If the ionic liquid is to be recirculated in a cyclic mode of operation, the ionic liquid can comprise up to 15% by weight, preferably up to 10% by weight, in particular up to 5% by weight, of precipitant(s) as described above.

The process can be carried out batchwise, semicontinuously or continuously.

The following examples serve to illustrate the invention.

Preliminary remark:

Cotton linters (hereinafter referred to as linters) or Avicel PH 101 (microcrystalline cellulose) were dried overnight at 80° C. and 0.05 mbar or 105° C. and 0.1 mbar.

The ionic liquids were dried overnight at 120° C. and from 0.1 to 0.05 mbar with stirring.

The average degree of polymerization DP of the cellulose used (if necessary) and the degraded cellulose were determined by measurement of the viscosity in Cuen solution.

Abbreviations:

EMIM HSO₄ 1-ethyl-3-methylimidazolium hydrogensulfate

BMIM Ac 1-butyl-3-methylimidazolium acetate

BMIM Cl 1-butyl-3-methylimidazolium chloride

BMMIM Cl 1-butyl-2,3-dimethylimidazolium chloride

DP average degree of polymerization

AGU anhydroglucose unit

### EXAMPLE 1

### Complete Degradation of Cellulose in EMIM HSO₄ at 100° C.

In a 50 ml protective gas flask with magnetic stirrer bar, 0.5 g of dried linters was stirred in 20.0 g of EMIM HSO₄ at 120° C. until a clear solution was formed. After cooling to 100° C., 0.05 g of water was added. (The ratio of AGU to water was 1:1). The reaction mixture was stirred at 100° C. for 16 hours; part of the mixture was then precipitated in twenty times the amount of water and another part was precipitated in twenty times the amount of methanol. In both cases, no precipitate was formed and only low molecular weight constituents were found in the gel chromatogram, which corresponds to complete degradation of the cellulose.

### EXAMPLE 2

### Degradation of Cellulose in BMIM Cl at 95° C./3 h

In a 50 ml protective gas flask with magnetic stirrer bar, 0.5 g of dried linters was stirred in 20.0 g of BMIM Cl at 120° C. After 3 hours, a clear solution was obtained. The reaction mixture was then sonicated for 3 hours in an ultrasonic bath (Bandelin electronic Sonorex Super RK 106; bath temperature: 95° C.); the cellulose was then precipitated in twenty times the amount of methanol, filtered, washed with methanol and dried overnight at 80° C. and 0.1 mbar. The yield of degraded cellulose was 0.485 g (97%). The DP of the cellulose obtained in this way was 380. The DP of the linters used was 3252.

### EXAMPLE 3

### Degradation of Cellulose in BMIM Cl at 95° C./4 h

In a 50 ml protective gas flask with magnetic stirrer bar, 0.5 g of dried linters was stirred in 20.0 g of BMIM Cl at 120° C. After 3 hours, a clear solution was obtained. The reaction mixture was then sonicated for 4 hours in an ultrasonic bath (Bandelin electronic Sonorex Super RK 106; bath temperature: 95° C.); the cellulose was then precipitated in twenty times the amount of methanol, filtered, washed with methanol and dried overnight at 80° C. and 0.1 mbar. The yield of degraded cellulose was 0.490 g (98%). The DP of the cellulose obtained in this way was 225. The DP of the linters used was 3252.

### EXAMPLE 4

### Degradation of Cellulose in BMIM Cl at 120° C.

In a 50 ml protective gas flask with magnetic stirrer bar, 0.5 g of dried linters was stirred in 20.0 g of BMIM Cl at 120° C. After 3 hours, a clear solution was obtained. The reaction mixture was then stirred at a bath temperature of 120° C. for 16 hours; the cellulose was then precipitated in twenty times the amount of methanol, filtered, washed with methanol and dried overnight at 80° C. and 0.1 mbar. The yield of degraded cellulose was 0.495 g (99%). The DP of the cellulose obtained in this way was 548. The DP of the linters used was 3252.

### EXAMPLE 5

### Thermal Degradation of Cellulose in BMIM Cl at 130° C.

In a 50 ml protective gas flask with magnetic stirrer bar, 0.5 g of dried linters was stirred in 20.0 g of BMIM Cl at 120° C. After 3 hours, a clear solution was obtained. The reaction mixture was then stirred at a bath temperature of 130° C. for 16 hours; the cellulose was then precipitated in twenty times the amount of methanol, filtered, washed with methanol and dried overnight at 80° C. and 0.1 mbar. The yield of degraded cellulose was 0.485 g (97%). The DP of the cellulose obtained in this way was 396. The DP of the linters used was 3252.

### EXAMPLE 6

### Degradation of Cellulose in BMIM Cl at 150° C.

In a 50 ml protective gas flask with magnetic stirrer bar, 0.5 g of dried Avicel PH 101 was stirred in 10.0 g of BMIM Cl at 120° C. After 3 hours, a clear solution was obtained. The reaction mixture was then stirred at a bath temperature of 150° C. for 2 hours; the cellulose was then precipitated in twenty times the amount of methanol, filtered, washed with methanol and dried overnight at 80° C. and 0.1 mbar. The yield of degraded cellulose was 0.490 g (98%). The DP of the cellulose obtained in this way was 51. The DP of Avicel PH 101 was 463.

### EXAMPLE 7

### Degradation of Cellulose in BMMIM Cl at 150° C.

In a 50 ml protective gas flask with magnetic stirrer bar, 0.5 g of dried Avicel PH 101 was stirred in 10.0 g of BMMIM Cl at 120° C. After 3 hours, a clear solution was obtained. The reaction mixture was then stirred at a bath temperature of 150° C. for 2 hours; the cellulose was then precipitated in twenty times the amount of methanol, filtered, washed with methanol and dried overnight at 80° C. and 0.1 mbar. The yield of degraded cellulose was 0.475 g (95%). The DP of the cellulose obtained in this way was 62. The DP of Avicel PH 101 was 463.

### EXAMPLE 8

### Degradation of Cellulose in BMIM Cl at 150° C.

In a 50 ml protective gas flask with magnetic stirrer bar, 0.5 g of dried linters was stirred in 10 g of BMIM Cl at 120° C. After 3 hours, a clear solution was obtained. The reaction mixture was then stirred at a bath temperature of 150° C. for 2 hours; the cellulose was then precipitated in twenty times the amount of methanol, filtered, washed with methanol and dried overnight at 80° C. and 0.1 mbar. The yield of degraded cellulose was 0.475 g (95%). The DP of the cellulose obtained in this way was 98. The DP of the linters used was 3252.

### EXAMPLE 9

### Degradation of Cellulose in BMIM Cl at 150° C.—Influence of the Reaction Time

In a 50 ml protective gas flask with magnetic stirrer bar, 0.5 g of dried Avicel PH 101 was stirred in 20.0 g of BMIM Cl at 120° C. for 12 hours. The clear reaction mixture was then stirred at a bath temperature of 150° C. After the times t which are shown in table 1, an aliquot was in each case taken, the cellulose was precipitated in twenty times the amount of methanol, filtered, washed with methanol and dried overnight at 80° C. and 0.1 mbar. The yield of degraded cellulose and its DP are reported in table 1.

TABLE 1

| Cellulose | t [h] | DP | Yield [%] |
|---|---|---|---|
| Avicel PH 101 (starting material) | — | 463 | — |
| Degraded cellulose | 2 | 24 | 100 |
| Degraded cellulose | 4 | 25 | 56.9 |
| Degraded cellulose | 6 | 14 | 48.0 |
| Degraded cellulose | 15*) | — | — |

*)No precipitate was formed on precipitation by means of methanol, which indicates complete degradation of the cellulose.

### EXAMPLE 10

### Degradation of Cellulose in BMIM Cl at 150° C.—Influence of the Reaction Time

In a 50 ml protective gas flask with magnetic stirrer bar, 0.5 g of dried linters was stirred in 20.0 g of BMIM Cl at 120° C. for 12 hours. The clear reaction mixture was then stirred at a bath temperature of 150° C. After the times t which are shown in table 2, an aliquot was in each case taken, the cellulose was precipitated in twenty times the amount of methanol, filtered, washed with methanol and dried overnight at 80° C. and 0.1 mbar. The yield of degraded cellulose and its DP are reported in table 2.

TABLE 2

| Cellulose | t [h] | DP | Yield [%] |
|---|---|---|---|
| Linters (starting material) | — | 3252 | — |
| Degraded cellulose | 2 | 45 | 99 |
| Degraded cellulose | 4 | 31 | 98 |
| Degraded cellulose | 6 | 30 | 78 |

### EXAMPLE 11

### Degradation of Cellulose in BMIM Ac at 120° C.—Influence of the Reaction Time

0.5 g of dried linters were dissolved in 20.0 g of BMIM Ac at 120° C. and after times t which are shown in table 3, an aliquot was in each case taken, the cellulose was precipitated in twenty times the amount of methanol, filtered, washed with methanol and dried at 60° C. and 0.05 mbar. The DPs of the degraded cellulose are reported in table 3.

TABLE 3

| Cellulose | t [h] | DP |
|---|---|---|
| Linters (starting material) | — | 3252 |
| Degraded cellulose | 2 | 1286 |
| Degraded cellulose | 4 | 1214 |
| Degraded cellulose | 6 | 1159 |

### EXAMPLE 12

### Degradation of Cellulose in BMIM Cl at 120° C.—Influence of the Reaction Time

0.5 g of dried linters were dissolved in 20.0 g of BMIM Cl at 120° C. and after times t which are shown in table 4, an aliquot was in each case taken, the cellulose was 10 precipitated in twenty times the amount of methanol, filtered, washed with methanol and dried at 60° C. and 0.05 mbar. The DPs of the degraded cellulose, which were determined by means of gel permeation chromatography, are reported in table 4.

TABLE 4

| Cellulose | t [h] | DP |
|---|---|---|
| Linters (starting material) | — | 1337 |
| Degraded cellulose | 2 | 907 |
| Degraded cellulose | 4 | 258 |
| Degraded cellulose | 6 | 109 |

### EXAMPLE 13

### Degradation of Cellulose in BMIM Ac at 100° C.—Influence of the Reaction Time

1.0 g of dried Avicel PH 101 was dissolved in 20.0 g of BMIM Ac at 100° C. and after times t which are shown in table 5, an aliquot was in each case taken, the cellulose was precipitated in twenty times the amount of methanol, filtered, washed with methanol and dried at 60° C. and 0.05 mbar. The DPs of the degraded cellulose are reported in table 5.

TABLE 5

| Cellulose | t [h] | DP |
|---|---|---|
| Avicel PH 101 (starting material) | — | 463 |
| Degraded cellulose | 2 | 406 |
| Degraded cellulose | 16 | 370 |

1: A process for the degradation of polysaccharides, oligosaccharides or disaccharides or derivatives thereof, wherein the polysaccharide, oligosaccharide or disaccharide or the corresponding derivative is dissolved in at least one ionic liquid and, if appropriate with addition of water, treated at elevated temperature.

2: The process according to claim 1, wherein a polysaccharide or a derivative thereof is used as polysaccharide, oligosaccharide or disaccharide or derivative thereof.

3: The process according to claim 2, wherein cellulose or a cellulose derivative is used as polysaccharide or derivative thereof.

4: The process according to claim 3, wherein cellulose is used as polysaccharide or derivative thereof.

5: The process according to claim 1, wherein the ionic liquid or mixture thereof is selected from among the compounds of the formula I,
[A]⁺ₙ[Y]ⁿ⁻ (I),
where
n is 1, 2, 3 or 4;
[A]⁺ is a quaternary ammonium cation, an oxonium cation, a sulfonium cation or a phosphonium cation; and
[Y]ⁿ⁻ is a monovalent, divalent, trivalent or tetravalent anion; or
the compounds of the formula II
[A¹]⁺[A²]⁺[Y]ⁿ⁻ (IIa), where n=2;
[A¹]⁺[A²]⁺[A³]⁺[Y]ⁿ⁻ (IIb), where n=3; or
[A¹]⁺[A²]⁺[A³]⁺[A⁴]⁺[Y]ⁿ⁻ (Ic), where n=4, and
[A¹]⁺, [A²]⁺, [A³]⁺ and [A⁴]⁺ are selected independently from among the groups specified for [A]⁺; and
[Y]ⁿ⁻ is as defined above.

6: The process according to claim 5, wherein [A]⁺ is a cation selected from among the compounds of the formulae (IIIa) to (IIIy) 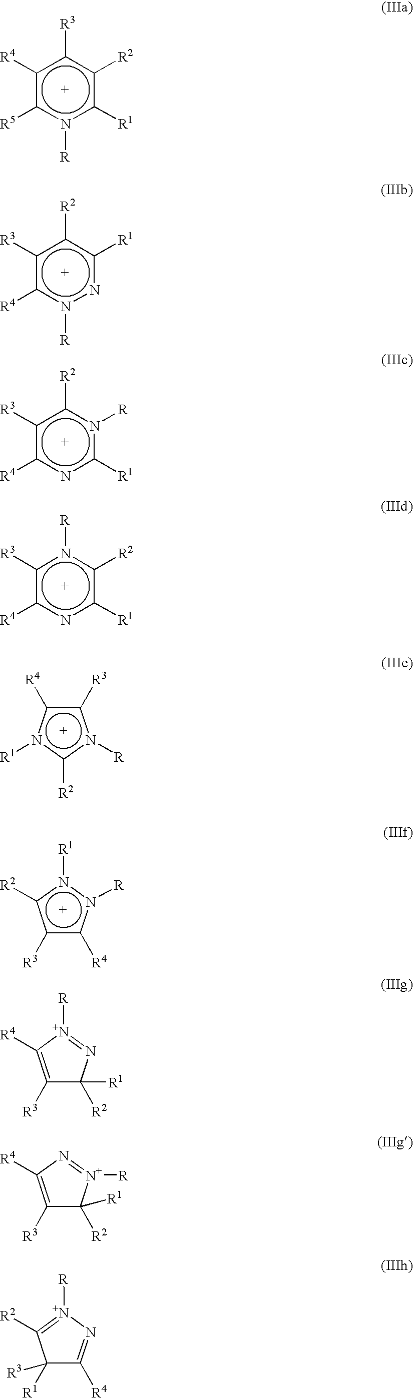 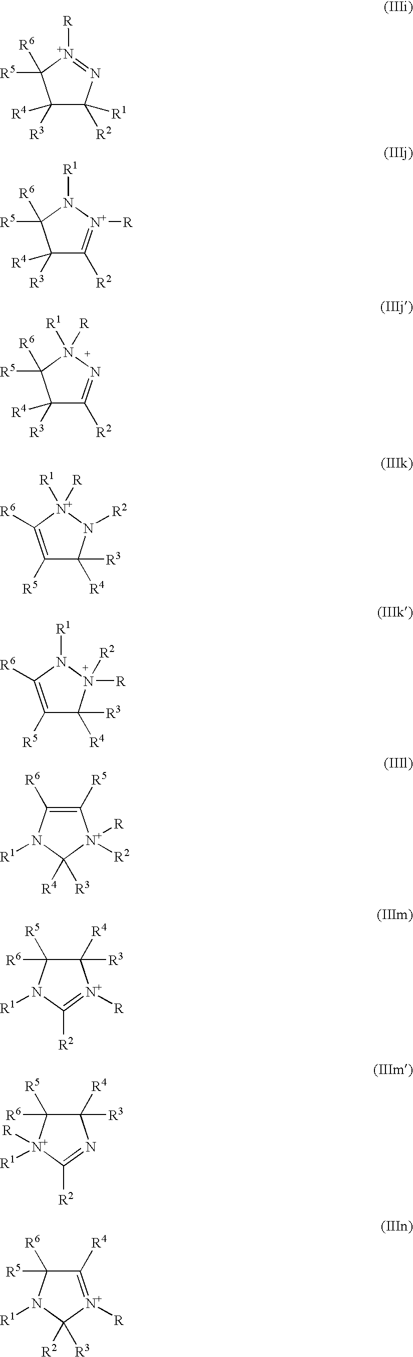 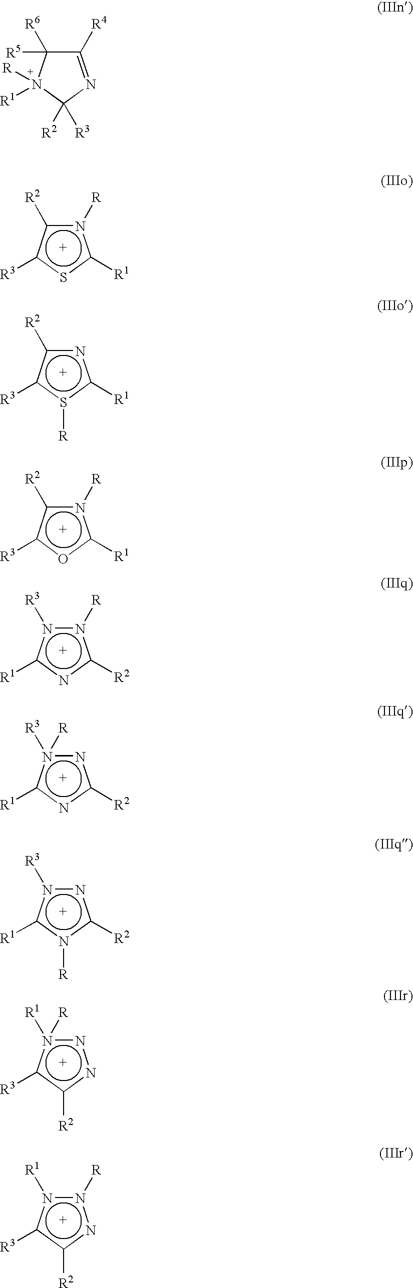 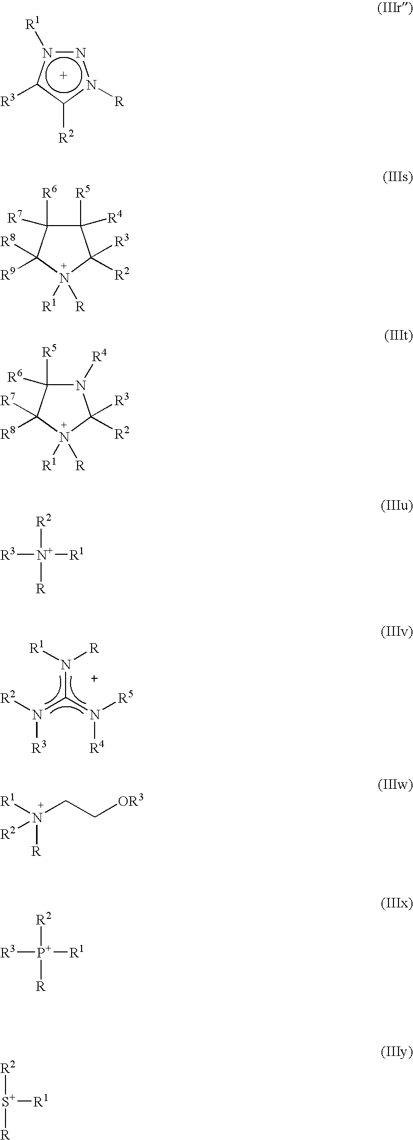
and oligomers comprising these structures, where
the radical R is hydrogen or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups; and
the radicals R¹ to R⁹ are each, independently of one another, hydrogen, a sulfo group or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups, where the radicals R¹ to R⁹ which are bound to a carbon atom (and not to a heteroatom) in the abovementioned formulae (III) can additionally be halogen or a functional group; or two adjacent radicals from the group consisting of R¹ to R⁹ may together also form a divalent, carbon-comprising organic, saturated or unsaturated, acyclic or cyclic, aliphatic, aromatic or araliphatic radical which has from 1 to 30 carbon atoms and may be unsubstituted or be interrupted or substituted by from 1 to 5 heteroatoms or functional groups.

7: The process according to claim 5, wherein [Y]ⁿ⁻ is an anion selected from among
the group of halides and halogen-comprising compounds of the formulae: F—, Cl—, Br—, I—, BF₄—, PF₆—, CF₃SO₃—, (CF₃SO₃)₂N—, CF₃CO₂—, CCl₃CO₂—, CN—, SCN—, OCN—
the group of sulfates, sulfites and sulfonates of the general formulae: SO₄²—, HSO₄—, SO₃²—, HSO₃—, R^{a}OSO₃—, R^{a}SO₃—
the group of phosphates of the general formulae PO₄³—, HPO²—, H₂PO₄—, R^{a}PO₄²—, HR^{a}PO₄—, R^{a}R^{b}PO₄—
the group of phosphonates and phosphinates of the general formulae: R^{a}HPO₃—,R^{a}R^{b}PO₂—, R^{a}R^{b}PO₃—
the group of phosphites of the general formulae: PO₃³—, HPO₃²—, H₂PO₃—, R^{a}PO₃²—, R^{a}HPO₃—, R^{a}R^{b}PO₃—
the group of phosphonites and phosphinites of the general formulae: R^{a}R^{b}PO₂—, R^{a}HPO₂—, R^{a}R^{b}PO—, R^{a}HPO—
the group of carboxylic acids of the general formula: R^{a}COO—
the group of borates of the general formulae: BO₃³—, HBO₃²—, H₂BO₃—, R^{a}R^{b}BO₃—, R^{a}HBO₃—, R^{a}BO₃²—, B(OR^{a})(OR^{b})(OR^{c})(OR^{d})—, B(HSO₄)—, B(R^{a}SO₄)—
the group of boronates of the general formulae: R^{a}BO₂²—, R^{a}R^{b}BO—
the group of silicates and silicic esters of the general formulae: SiO₄⁴—, HSiO₄³—, H₂SiO₄²—, H₃SiO₄—, R^{a}SiO₄³—, R^{a}R^{b}SiO₄²—, R^{a}R^{b}R^{c}SiO₄—, HR^{a}SiO₄²—, H₂R^{a}SiO₄—, HR^{a}R^{b}SiO₄—
the group of alkylsilane and arylsilane salts of the general formulae: R^{a}SiO₃³—, R^{a}R^{b}SiO₂²—, R^{a}R^{b}R^{c}SiO—, R^{a}R^{b}R^{c}SiO₃—, R^{a}R^{b}R^{c}SiO₂—, R^{a}R^{b}SiO₃²—
the group of carboximides, bis(sulfonyl)imides and sulfonylimides of the general formulae: 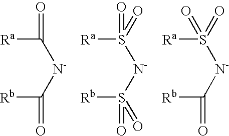
the group of methides of the general formula: 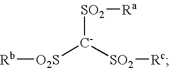
where the radicals R^{a}, R^{b}, R^{c} and R^{d} are each, independently of one another, hydrogen, C₁-C₃₀-alkyl, C₂-C₁₈-alkyl which may optionally be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogen- and/or sulfur-comprising heterocycle, where two of them may together form an unsaturated, saturated or aromatic ring which may optionally be interrupted by one or more oxygen and/or sulfur atoms and/or one or more unsubstituted or substituted imino groups, where the radicals mentioned may each be additionally substituted by functional groups, aryl, alkyl, aryloxy, alkyloxy, halogen, heteroatoms and/or heterocycles.

8: The process according to any claim 6, wherein [A]⁺ is a cation selected from the group consisting of the compounds IIIa, IIIe, IIIf; IIIg, IIIg′, IIIh, IIIi, IIIj, IIIj′, IIIk, IIIk′, IIIl, IIIm, IIIm′, IIIn and IIIn′.

9: The process according to claim 6, wherein [A]⁺ is a cation selected from the group consisting of the compounds IIIa, IIIe and IIIf.

10: The process according to claim 7, wherein [Y]ⁿ⁻ is an anion selected from the group consisting of halides and halogen-comprising compounds, the group consisting of carboxylic acids, the group consisting of SO₄²—, SO₃²—, R^{a}OSO₃— and R^{a}SO₃— and the group consisting of PO₄³— and R^{a}R^{b}PO₄—.

11: The process according to claim 9, wherein [Y]ⁿ⁻ is an anion selected from the group consisting of HSO₄—, HPO₄²—, H₂PO₄— and HR^{a}PO₄—.

12: The process according to any claim 1, wherein the concentration of polysaccharide, oligosaccharide or disaccharide or derivative thereof in the ionic liquid is in the range from 0.1 to 50% by weight, based on the total weight of the solution.

13: The process according to claim 12, wherein water is added.

14: The process according to claim 1, wherein the treatment is carried out without addition of water.

15: The process according to claim 1 wherein the hydrolysis is carried out at a temperature in the range from 0 to 200° C.

16: The process according to claim 1, wherein the degradation is quenched by addition of a solvent in which the degradation products of the polysaccharide are not soluble.
